(19) United States
(12) Patent Application Publication
(10) Pub. No.: US 2004/0170726 A1
(43) Pub. Date: Sep. 2, 2004

(54) Preparation of wort and beer of high nutritional value, and corresponding products

(76) Inventor: Angeliki Oste Triantafyllou, Lund (SE)

Correspondence Address: DICKSTEIN SHAPIRO MORIN & OSHINSKY LLP, 2101 L STREET NW, WASHINGTON, DC, 20037-1526, US

(21) Appl. No.: 10/795,513

(22) Filed: Mar. 9, 2004

Related U.S. Application Data
(63) Continuation of application No. 09/178,840, filed on Oct. 26, 1998, now abandoned.

(51) Int. Cl. C12H 1/00

(52) U.S. Cl. 426/100

(57) ABSTRACT

In a process for the production of a cereal beer made from a cereal or mixture of cereals, an aqueous cereal slurry is prepared from wet milled rolled or crushed cereal, heat treated cereal flour, and their mixtures. The slurry is malted at a temperature above 50° C. in the presence of starch degrading enzymes and, optionally, protein degrading enzymes. Degradation of soluble β-glucan is avoided by controlling β-glucanase activity. Upon cooling, insoluble material is removed to form a cereal wort which is boiled with hops to destroy all enzymatic activity. Substantial amounts of boiled traditional wort may be added during the process. Fermentation of the wort produces a beer containing a high amount of soluble β-glucan. Also disclosed are products prepared by the process.

### BACKGROUND OF THE INVENTION

The present invention relates to a process for the preparation of a beer of high nutritional value from cereals, in particular from oats, barley, and their mixtures, and to corresponding products, in particular wort and beer of high nutritional value made from oats, barley, and their mixtures.

Water soluble native β-glucan is of major nutritional interest. It is the chemical constituent of ‘soluble dietary fiber’, SDF, considered to be responsible for the association between oats products and reduced risk for coronary heart disease. In this context the term ‘native’ indicates that the carbohydrate has not been degraded enzymatically to a substantial extent during its isolation. A variety of health food products rich in SDF are currently on the market.

Oats is particularly rich in SDF. Oats SDF is documented as being particularly healthy. But also barley and other cereals contain SDF.

Conventional malting favors the presence of β-glucanase activity which either develops during the malting process or is caused by the addition of β-glucanase to the mash in order to facilitate filtration of the beer. Degradation of soluble β-glucan by β-glucanase results in loss of nutritional value.

### SUMMARY OF THE INVENTION

It is an object of the present invention to provide a process for the production of a beer of high nutritional value from cereals, in particular from oats, barley, and their mixtures.

It is another object of the invention to provide corresponding products, in particular high nutritional value wort and beer made from oats, barley, and their mixtures. ‘High nutritional value’ refers to a high content of soluble β-glucan obtained by preservation of a substantial portion of the soluble β-glucan contained in the raw material.

The invention is based on the insight that conventional malting should be avoided when producing a cereal wort, in particular an oats or barley wort or a mixed oats/barley wort, having a high content of soluble β-glucan. Avoidance of conventional malting prevents β-glucan degrading β-glucanase from being formed. In the brewing process of the invention the malting step is substantially modified. Instead of being produced or activated in a malting step, enzymes required for degrading starch and, optionally, protein, are added prior to or/and during the mashing step, imitating conventional malting but avoiding β-glucan degradation. The enzymes may be added in pure form but also in form of cereal derived materials containing substantial amounts of carbohydrates in addition to or instead of said enzymes.

‘Conventional malting’ is defined as process of germinating a steeped cereal under controlled temperature conditions (about 15° C. and 100% relative humidity) for a couple of days to make the corn produce starch and protein metabolizing enzymes; germination is stopped by gentle heating (kilning) under a flow of dry air to reduce humidity, whereupon the rootlets formed in the process are removed.

Modification of conventional malting according to the invention may consist in the complete omission of the germination step or in a substantial reduction thereof, providing incompletely germinated grain. The activation of various carbohydrate degrading enzymes does not proceed at the same rate from the start of germination. In particular, the rate of activation of amylolytic enzymes, such as α-amylase, develops substantially faster than that of β-glucanase. This allows to carry germination to a point at which substantial amylolytic activity has developed in the corn while β-glucanase activity is still insignificant or even cannot be detected at all. This optimum point, which is dependent on the cereal variety employed, germination temperature and humidity, etc., can be determined by monitoring the activity of the respective enzyme. The length of the germination phase thus should be selected to provide a partially germinated oats, barley or other cereal grain having substantial amylolytic activity while essentially lacking β-glucanase activity. ‘Essentially lacking β-glucanase activity’ signifies a degree of activity which does not decrease the yield of soluble β-glucan by more than 20% by weight, more preferred 10% by weight, compared to the yield obtained from the corresponding source of non-germinated corn.

The modified malting process according to the invention comprising controlled malting and, optionally, selective enzyme inactivation, is useful in the production of cereal wort and cereal beer containing substantial amounts of soluble β-glucan while avoiding undesirable β-glucan degradation. The present invention also comprises a process for producing wort and beer rich in soluble β-glucan complying with regulatory requirements in various countries, such as the German ‘purity law’.

According to the invention is disclosed a process for producing, from a cereal or mixture of cereals, in particular from one or several of rolled oats, rolled barley, oats flour, barley flour, fractions of such flours rich in β-glucan, incompletely germinated oats, and incompletely germinated barley, a cereal wort or beer having a high content of soluble β-glucan, in particular an oats, barley or mixed oats/barley wort or beer.

The process of the invention for the production of a beer of the aforementioned kind, comprises the following steps:

forming an aqueous cereal slurry containing from 10% to 30%, preferably from 15% to 25% by weight of a wet milled cereal or a mixture of wet milled cereals, such as rolled oats, rolled barley, heat treated oats flour, heat treated barley flour, incompletely germinated oats, incompletely germinated barley, and their mixtures;

mashing the slurry at a temperature above 50° C., preferably of 54-65° C., most preferred of about 58° C., in the presence of starch degrading enzymes,

cooling to a temperature below 50° C., preferably to about 40° C.,

removing insoluble material to form a wort;

optionally, extracting the insoluble material with water and adding the extract to the wort;

transferring the wort to a boiling tank, optionally to a storage tank before transferring it to said boiling tank;

boiling the wort with hops according to taste at conditions sufficient to destroy all enzymatic activity, thereby forming a boiled wort;

cooling the boiled wort to room temperature or lower, preferably to a temperature of about 10° C.;

optionally, adding a conventional malt wort boiled with hops to the boiled wort prior to or subsequent to cooling;

adding a yeast culture;

fermenting the mixture to produce a cereal beer having a high content of soluble β-glucan.

By stopping the process of the invention at an appropriate stage a wort, boiled with hops or not, can be produced.

This process for producing a wort having a high content of soluble β-glucan is also comprised by the invention.

A variation of the method according to the invention comprises adding a boiled conventional malt wort to the wort of the invention prior to boiling or adding the wort of the invention to a conventional boiled malt wort in the process of producing a beer having a high content of soluble β-glucan. By stopping this variant process according to the invention at an appropriate stage a mixed wort comprising the wort of the invention, boiled with hops or not, and a conventional boiled wort, can be produced. This process for producing such a ‘mixed’ wort having a high content of soluble β-glucan is also comprised by the invention.

The use of an oats flour and/or barley flour fraction rich in β-glucan or a mixture thereof is preferred. Particularly preferred is the use of such an oats flour fraction.

The process of the invention conserves most of soluble β-glucan found in the cereal, such as more than 50% thereof, since the enzymes used for the degradation of starch are essentially free from β-glucanase activity and since mainly the insoluble fibers are removed during the process. This leaves the β-glucan soluble dietary fibers in the wort. In traditional brewing, SDF is degraded by the β-glucanase activity developing during malting.

In the process of the invention, the added enzyme(s) degrade starch and proteins to small fermentable molecules. Starch degradation predominantly yields maltose and glucose, as well as small amounts of maltotriose. Protein degradation yields small peptides and amino acids. β-Amylase in combination with amyloglucosidase or α-amylase produces maltose and glucose. β-Amylase in combination with pullulanase produces maltose.

A combination of β-amylase, pullulanase, and amyloglucosidase produces glucose. α-Amylase in combination with amyloglucosidase produces large amounts of glucose. Any combination of these enzymes that yields a fermentable wort with essentially intact SDF can be used. The enzymes or part thereof need not be added as such but can be provided in form of cereal derived raw material containing them, including non-malted barley, barley or oats malted in a way so as to conserve certain enzyme activity, and conventional heat treated malt wort.

A particularly preferred process according to the invention for the production of a beer rich in soluble β-glucan, comprises the following steps:

forming an aqueous oats slurry containing from 15% to 25% by weight of wet milled rolled oats, heat treated oats flour or incompletely germinated oats;

mashing the slurry at a temperature of about 58° C., in the presence of added one or several of β-amylase, amyloglucosidase, α-amylase, pullulanase, protease;

cooling to a temperature below 50° C.;

removing solids to form a wort rich in soluble β-glucan;

optionally, extracting the solid residue with water and adding the extract to the oats wort;

transferring the oats wort to a boiling tank;

boiling the oats wort with hops according to taste;

cooling the boiled oats wort to room temperature or lower, preferably to a temperature of about 10° C.;

optionally, adding conventional malt wort boiled with hops before or after the boiling step;

adding a yeast culture;

fermenting the mixture to produce an oats bear having a high content of soluble β-glucan.

The process of the invention can be directly integrated into conventional brewing processes. The only equipment required in addition to that usually found on site is a device for the milling of barley and rolled oats if rolled oats is used instead of an oats flour fraction, a heat exchanger and a decanter centrifuge or similar separation equipment. Tanks are usually abundant at any brewery.

According to the present invention is also disclosed a cereal beer containing a high amount of soluble β-glucan, including a beer made from a combination of the wort according to the invention and a traditional malted wort produced from other raw materials, such as a mixed wort containing more than 30%, preferably more than 50% of the wort according to the invention. A cereal beer of the invention produced solely from rolled oats or an oats flour fraction contains more than 0.3% by weight of soluble β-glucan, preferably more than 0.5%, and even more than 0.6%. A cereal beer made from a combination of worts contains at least a corresponding amount of soluble β-glucan, that is, an amount which is about proportional to the volume-% of the beer derived from oats wort; preferred is an amount of more than 0.2% by weight of soluble β-glucan.

According to the present invention is also disclosed an oats wort containing more than 0.3% by weight of soluble β-glucan, preferably more than 0.5%, and even more than 0.6%. Also disclosed is a mixed wort containing at least an amount of soluble β-glucan corresponding to the proportion of the oats wort in the mixed wort; preferred is an amount of more than 0.2% by weight of soluble β-glucan.

The person skilled in the art will understand that, instead of oats alone or oats in combination with barley or barley alone, any suitable other cereal or mixture of cereals can be employed, such as maize, sorghum, rice, wheat, rye, and potato, the process of the invention being adapted to the requirements of the particular cereal or mixture of cereals used.

Where appropriate, ‘cereal(s)’ includes material(s) derived from a cereal or mixture of cereals. ‘Effective amount’ of a carbohydrate degrading enzyme is an amount sufficient to degrade at least 0.1% of the glycosidic bonds of the starch contained in the starting material. ‘Final product’ refers to any product obtained in the process of the invention, such as a non-boiled oats wort; a final product can be stored for a shorter or longer time prior to being further treated. For a general background of brewing technology reference is made to T. O'Rourke: Brewing. Industrial Enzymology, 2^{nd} Edition, p. 105-131, including further literature cited therein.

Further advantages of the invention are disclosed in the claims and will also be evident from a number of preferred but not limiting embodiments of the invention.

### DETAILED DESCRIPTION OF THE INVENTION

Materials. A commercial heat-treated oats flour fraction high in β-glucan, ‘HAVREMJÖL C45’, was obtained from Skåne-möllan (Tågarp, Sweden). Oats flour fractions high in β-glucan can be also be obtained by applying the teaching of U.S. Pat. No. 5,063,078 (Frohse) to oats. Rolled oats is commercially available from Vårgårda (Sweden), Skåne-möllan, and other sources. β-Amylase (barley) was obtained from Genencor International, Inc. (Rochester, N.Y., USA) and Rhôdia Ltd. (Cheshire, UK). Pullulanase and α-amylase was obtained from Genencor or Novo Nordisk Nordisk, (Valby, Denmark). Amyloglucosidase was obtained from Novo Nordisk. Suitable proteases can be obtained from a variety of manufacturers.

### EXAMPLE 1

Preparation of oats wort and oats beer from rolled oats. Rolled oats are wet milled at a temperature of about 62° to yield a slurry which is transferred to a double mantled (for heating) stainless steel reaction tank provided with efficient stirring equipment. The proportion of oats to water can be varied within a wide range. For most applications a proportion of from about 15% w/v to about 25% w/v is appropriate. A combination of enzymes is employed which imitates the malting process used at the respective brewery. For instance, β-amylase is added at a dosage of from 10,000 to 22,000 Dp° per kg of oats, preferably of about 18,000 Dp° per kg of oats, to initiate the degradation of starch to maltose. Pullulanase and/or amyloglucosidase is added to the slurry, each enzyme preparation at a dosage of 300-1,200 enzyme units per kg of oats to improve the fermentability of the wort. The temperature is lowered to about 57° C., and α-amylase is added at a dosage of from about 800 to about 5,000 amylase units per kg of oats, optimally of about 2,500 units per kg. After one hour's reaction the refractometer reading should be from about 6% to about 10%, preferably at least 8%, due to the production of maltose and glucose. Stirring of the slurry continues until a highly fermentable wort of at least about 12%, preferably of about 14%, is obtained. Addition of iodine to a wort sample demonstrates that essentially all starch has been consumed. Protease is added at a dosage of 3-12 protease units per kg of oats to further increase fermentability of the wort by producing amino acids and low molecular weight peptides later to be consumed for yeast growth. A reaction period of about 30 min will usually be sufficient for the action of protease. Stirring is stopped and the solids are left to settle in the reaction tank while the wort is emptied from its top and cooled to 40° C. in a heat exchanger. The solids are continuously removed by a decanter centrifuge. To provide for quantitative extraction of SDF water (1 liter/kg of oats) is added to the residue remaining in the reaction tank. The slurry is stirred and pumped through the decanter into the boiling tank. The thus prepared oats wort is boiled with hops, for example 2 g-5 g of hops per kg of oats, for about 70 min. The boiled wort is cooled to 10° C., and yeast is added.

The same procedure has been employed for producing a boiled barley wort from a corresponding amount of rolled barley.

Optionally the oats or barley wort thus obtained (boiled or not boiled) is mixed with a traditional barley malt wort (boiled with hops), for instance with an equal volume thereof. A typical beer prepared with equal amounts of oats wort according to the invention and traditional barley malt wort (lager) contains 4.8% by volume of alcohol, has a color of at least 8.0 EBC, a pH value of 5.0 and a bitterness of about 13-14 EBU. The β-glucan content of the mixed wort and the beer prepared from it was about 0.6%. The β-glucan content of the oats wort was 1.2%.

### EXAMPLE 2

Preparation of oats wort and oats beer from an oats flour fraction. A heat treated oats flour fraction (Skåne-möllan) is used instead of the rolled oats of Example 1. The oats flour fraction is suspended in water in a concentration of about 20-30% w/v at a temperature of 58-65° C. For the rest the process of Example 1 is followed.

The same procedure is applicable to the preparation of cereal wort or beer according to the invention from cereal flour, in particular barley flour.

### EXAMPLE 3

Preparation of a ready-to-use enzyme enriched oats flour composition. The enzymes of Example 1 are thoroughly mixed in a double cone blender with a corresponding amount of an oats flour fraction high in β-glucan. The water content of the preparation should be the same or lower than that of commercial air dry oats flour to assure good storing properties. Addition of warm water restores enzyme activity. Other cereal flour than oats flour may be used, for instance barley flour, to obtain a corresponding enzyme enriched cereal flour composition.

### EXAMPLE 4

Preparation of a mixed oats/barley wort in the absence of added enzymes. Heat treated oats flour (Skåne-möllan) and/or mildly malted and optionally heat treated oats, and milled or crushed barley (barley grits) malted under mild conditions (about 10% or more of total solids) are mixed in a tank. The barley malt supplies β-amylase activity (approximately 50-80 DP°/g). Its malting conditions were selected to avoid production of β-glucanase activity. This can be achieved by either using short malting times or selective β-glucanase inactivation by heat treating the malt. In a second tank conventional malting of barley takes place.

The malt extract, that is, the liquid phase from the barley malting tank, contains a variety of enzymes among which β-glucanase is detrimental for the desired product. Therefore it is heat treated by means of a heat exchanger to ensure inactivation of β-glucanase prior to adding it to the barley/oats malt slurry tank. β-glucanase is less stable to heat than α-amylase. The partial loss of β-amylase during the heat treatment can be compensated for by adding the aforementioned milled (crushed) and specially malted barley to the oats. Otherwise the process is carried out as in Example 1 and with corresponding amounts of raw materials and additives.

What is claimed is:

1. A process for the production of a cereal wort or beer having a high content of soluble β-glucan of more than 0.2 wt % from a cereal or mixture of cereals in which a β-glucanase activity of any ingredient employed in the process will not decrease soluble β-glucan by more than 20 wt % compared to the yield from the corresponding source of non-germinated cereal or mixture of cereals, the process comprising the steps of:
inactivating β-glucanase in at least one cereal to produce a treated cereal;
forming an aqueous cereal slurry substantially free of β-glucanase activity and containing from 10% to 30% by weight of the treated cereal, the cereal being wet or dry milled; and
mashing the aqueous cereal slurry at a temperature above 50° C. in the presence of at least one starch degrading enzyme and at least one protein degrading enzyme.

2. The process of claim 1, further comprising the following steps:
cooling the mashed slurry to a temperature below 50° C.; and
removing the insoluble material to form the cereal wort.

3. The process of claim 2, including the step of combining boiled malt wort with said cereal wort.

4. The process of claim 1, wherein the at least one cereal is oats or barley or a mixture thereof.

5. The process of claim 2, wherein the process conditions are controlled such that more than 50% of the soluble β-glucan contained in the cereal is preserved in the cereal wort.

6. The process of claim 2, further comprising the steps of:
boiling the wort with hops at conditions sufficient to destroy all enzymatic activity to form a boiled wort;
cooling the boiled wort to room temperature or lower;
adding yeast to the boiled wort; and
fermenting the mixture to produce a cereal beer having a high content of soluble β-glucan.

7. The process of claim 6, wherein the process conditions are controlled such that more than 50% of soluble β-glucan contained in the cereal is preserved in the cereal beer.

8. The process of claim 1, wherein the at least one cereal is a malted cereal selected from oats, barley and a mixture thereof.

9. The process of claim 1, wherein the step of inactivating comprises heat treating the cereal sufficiently to lack β-glucanase activity.

10. The process of claim 1 wherein the mashing temperature is from 54 to 65° C.

11. The process of claim 10, wherein the mashing temperature is about 58° C.

12. The process of claim 1, wherein the starch degrading enzyme is amylase, optionally in combination with pullulanase or amylogucosidase or both.

13. The process of claim 1, in which the high content of soluble β-glucan is more than 0.3%.

14. The process of claim 1, in which the high content of soluble β-glucan is more than 0.5%.

15. The process of claim 1, wherein the at least one cereal includes at least one member selected from the group consisting of wet milled rolled oats, wet milled rolled barley, wet milled crushed barley, incompletely germinated oats, incompletely germinated barley, heat treated oats flour, heat treated barley flour, said incompletely germinated oats and incompletely germinated barley or a heat treated member of said group.

16. The process of claim 1, wherein the at least one protein degrading enzyme is added after the at least one starch degrading enzyme has consumed essentially all starch in the slurry.

17. The process of claim 1, wherein the process conditions are controlled such that more than 50% of the soluble β-glucan contained in the cereal is preserved in the mashed slurry.

18. A process for the production of a cereal wort or beer having a high content of soluble β-glucan of more than 0.2 wt % from a cereal or mixture of cereals, the process comprising the steps of:
inactivating β-glucanase in the cereal or mixture of cereals to produce treated cereal;
mashing the treated cereal in a slurry substantially free of β-glucanase activity; and
utilizing amylolytic enzymes during mashing having β-glucanase activity sufficient only to eliminate from the treated cereal or mixture of cereals not more than 50% of soluble β-glucan which is contained before the process is effected in the cereal or mixture of cereals.

19. The process of claim 18 in which the cereal is barley or oats or a mixture thereof.
